(19) United States
(12) Patent Application Publication
(10) Pub. No.: US 2024/0235749 A9
(43) Pub. Date: Jul. 11, 2024

(54) COMMUNICATION APPARATUS, WIRELESS COMMUNICATION SYSTEM, COMMUNICATION METHOD, AND COMPUTER-READABLE STORAGE MEDIUM

(71) Applicant: Canon Kabushiki Kaisha, Tokyo (JP)

(72) Inventor: SHOHEI UEDA, Tokyo (JP)

(21) Appl. No.: 18/477,707

(22) Filed: Sep. 29, 2023

(30) Foreign Application Priority Data
Oct. 25, 2022 (JP) 2022-170866

(51) Int. Cl. H04L 5/00; H04W 72/0453

(52) U.S. Cl. CPC H04L 5/001; H04W 72/0453

(57) ABSTRACT

A communication apparatus, which execute wireless communication with another communication apparatus, comprising a control unit for controlling to communicate with a first mode in which wireless communication is performed via a relay apparatus and a second mode in which wireless communication is performed not via a relay apparatus, an acquisition unit for acquiring information of a frequency band used for communication in the first and second modes, and a setting unit for setting such that, when communication in the first and second modes are performed in a first frequency band, the communication in the first mode is performed in a part of a frequency bandwidth in the first frequency band, and the communication in the second mode is performed in another part of a frequency bandwidth in the first frequency band.

### BACKGROUND OF THE INVENTION

### Field of the Invention

The present invention relates to mainly a communication apparatus.

### Description of the Related Art

Among communication apparatuses, there are those that can execute wireless communication via an access point and wireless communication not via an access point in parallel (see Japanese Patent Laid-Open No. 2012-019487).

As usage patterns of communication apparatuses are diversifying, further improvement in convenience of the communication apparatuses may generally be required.

### SUMMARY OF THE INVENTION

The present invention provides an advantageous technique for improving the convenience of the communication apparatus.

One of the aspects of the present invention provides a communication apparatus that can execute wireless communication with another communication apparatus, the communication apparatus comprising at least one memory and at least one processor and/or at least one circuit which function as a control unit configured to control to communicate with at least one of a plurality of communication modes including a first mode in which wireless communication is performed with another communication apparatus via a relay apparatus by a communication scheme compliant with a predetermined communication standard, and a second mode in which wireless communication is performed with another communication apparatus not via a relay apparatus by a communication scheme compliant with the predetermined communication standard, an acquisition unit configured to acquire information of a frequency band used for communication in the first mode and a frequency band used for communication in the second mode, and a setting unit configured to set such that, when communication in the first mode and communication in the second mode are both performed in a first frequency band, the communication in the first mode is performed in a part of a frequency bandwidth in the first frequency band, and the communication in the second mode is performed in another part of a frequency bandwidth in the first frequency band.

Further features of the present invention will become apparent from the following description of exemplary embodiments (with reference to the attached drawings).

### BRIEF DESCRIPTION OF THE DRAWINGS

FIG. 1 is a diagram illustrating an example of a configuration of a wireless communication system according to an embodiment;

FIGS. 2A and 2B are diagrams respectively illustrating an example of a configuration of a mobile terminal and an MFP;

FIGS. 3A to 3G are diagrams illustrating examples of display screens for performing various settings of wireless direct communication;

FIG. 4 is a flowchart for changing the setting of wireless direct communication;

FIG. 5 is a flowchart for changing the setting of wireless direct communication;

FIG. 6 is a flowchart for changing the frequency bandwidth of wireless direct communication; and

FIG. 7 is a flowchart for changing the frequency bandwidth of wireless direct communication.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

(System Configuration)

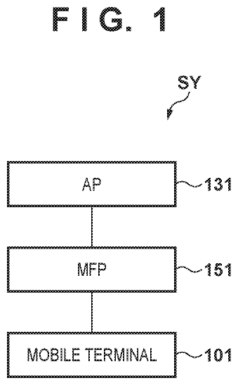

FIG. 1 illustrates an example of a configuration of a wireless communication system SY according to an embodiment. The wireless communication system SY is configured such that a plurality of communication apparatuses can wirelessly communicate with each other, and the wireless communication system SY includes an Access Point (AP) 131, a Multi Function Peripheral (MFP) 151, and a mobile terminal 101 in the present embodiment. Here, the mobile terminal 101 is an example of an electronic terminal, which is typically a notebook computer, a smartphone or the like. The wireless communication system SY may also be referred to as communication system or simply as system or the like.

The MFP 151 has a printing function, a reading and scanning function, a facsimile (FAX) function or the like. In addition, the MFP 151 further includes a communication function, whereby it can perform wireless communication with the mobile terminal 101. Here, a facsimile apparatus, a scanner apparatus, a projector, a single function printer or the like may be used in place of the MFP 151. In addition, an apparatus including a printing function may also be referred to as an image forming apparatus.

The AP 131 is provided independently of the mobile terminal 101 and the MFP 151, and functions as a base-station apparatus or a relay apparatus of a Wireless LAN (WLAN). Here, the AP 131 may be referred to as an external access point, an external wireless base station, an external parent station, or simply a parent station.

The MFP 151 can execute communication in an infrastructure mode of the WLAN via the AP 131. The infrastructure mode is a mode with which the MFP 151 communicates with another apparatus via an external apparatus (here, AP 131) forming a network, and may also be referred to as wireless infrastructure mode or the like. The connection with an external AP established by the MFP 151 operating in the infrastructure mode may be referred to as infrastructure connection.

In infrastructure connection, the MFP 151 of the present embodiment operates as a child station and the external AP 131 operates as a parent station. The parent station determines a communication channel that forms a network and is used in the network, and the child station uses a communication channel determined by the parent station in the network to which the child station belongs.

The AP 131 can perform wireless communication with a communication apparatus that is authenticated by the AP 131 having permitted connection to the AP 131, and relay wireless communication between the communication apparatus and another communication apparatus. In addition, the AP 131 can be connected to a wired communication network, for example, and relay communication between a communication apparatus connected to the wired communication network and another communication apparatus wirelessly connected to the AP 131.

The mobile terminal 101 and the MFP 151, by the WLAN communication function included in each of the mobile terminal 101 and the MFP 151, perform wireless communication in the wireless infrastructure mode via the AP 131, or in a Peer-to-Peer (P2P) mode not via the AP 131. The P2P mode is a mode in which the MFP 151 directly communicates with another apparatus (here, the mobile terminal 101) not via an external device forming a network, and may also be referred to as a wireless direct communication mode, a direct communication mode or the like. It is assumed in the present embodiment that the P2P mode is compliant with the IEEE802.11 series and includes Wi-Fi Direct (trade name, (WFD)), soft AP mode or the like.

And, it is assumed in the present embodiment that the P2P mode includes an AP mode in which the MFP 151 operates as an AP. In the AP mode, connection information (SSID, password, etc.) of the AP to be enabled in the MFP 151 can be arbitrarily set by a user.

The P2P mode may further include, for example, a WFD mode for the MFP 151 to communicate using WFD. Which of the plurality of WFD compatible devices may operate as the parent station may be determined based on a predetermined sequence (e.g., Group Owner Negotiation), it may also be determined by other methods. Here, an apparatus which is WFD compatible and can become a parent station may be referred to as a Group Owner.

The unmediated connection with another apparatus established by the MFP 151 operating in the P2P mode may be referred to as direct connection. In this connection, the MFP 151 of the present embodiment operates as a parent station, and another apparatus (the mobile terminal 101, etc.) operates as a child station.

An aspect of communication based on the aforementioned infrastructure connection is referred to as wireless infrastructure communication, and an operation mode including the connection and the communication thereof may be collectively and simply referred to as wireless infrastructure. In addition, an aspect of communication based on the aforementioned direct connection is referred to as wireless direct communication, and an operation mode including the connection and the communication thereof may be collectively and simply referred to as wireless direct.

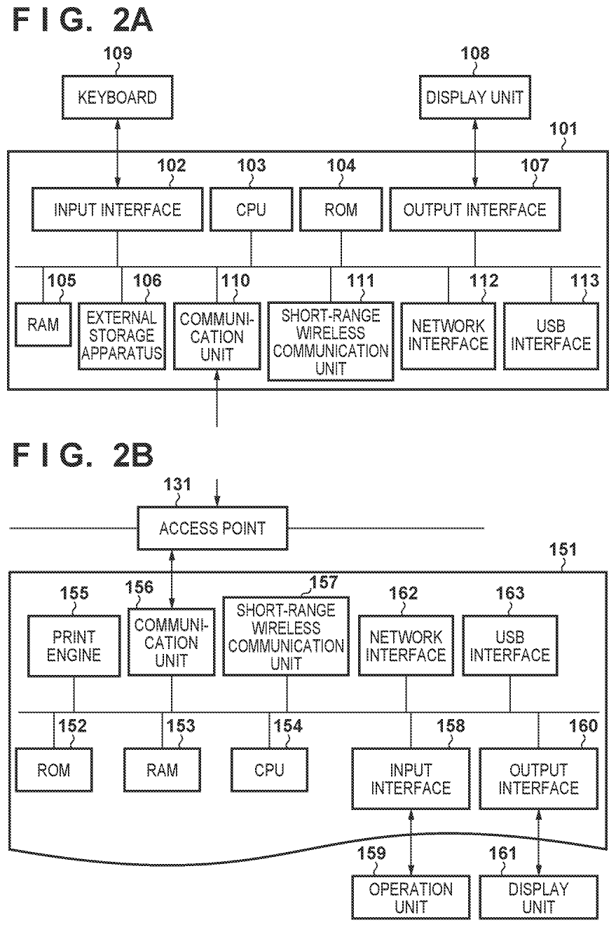

FIGS. 2A and 2B respectively illustrate an example of a configuration of the mobile terminal 101 and the MFP 151.

The mobile terminal 101 includes an input interface 102, a Central Processing Unit (CPU) 103, a Read Only Memory (ROM) 104, and a Random Access Memory (RAM) 105. In addition, the mobile terminal 101 includes an external storage apparatus 106, an output interface 107, a display unit 108, a keyboard 109, a communication unit 110, a short-range wireless communication unit 111, a network interface 112, and a USB interface 113.

The input interface 102 accepts an operation input (data input, operation instruction, etc.) from a user operating the keyboard 109 or other operation units. The operation unit may be a physical keyboard, a physical button or the like, it may also be a virtual keyboard, a virtual button or the like displayed on the display unit 108. In other words, the input interface 102 can also accept an operation input from the user via the display unit 108, and may form a touch panel display together with the display unit 108.

The functions of the mobile terminal 101 can be implemented by the CPU 103, the ROM 104, the RAM 105 and the like functioning together as a computer. The CPU 103 operates as a system control unit that causes the entire system of the mobile terminal 101 to function. The ROM 104 stores control programs executed by the CPU 103, data tables, programs of an embedded OS (operating system) or the like. In the aforementioned manner, software execution control such as scheduling, task switching, and interruption processing is performed under management of the embedded OS.

The RAM 105, including a Dynamic Random Access Memory (DRAM), a Static Random Access Memory (SRAM) or the like, is used as a main memory and a work memory of the CPU 103. The RAM 105 stores, for example, data, variables or the like used for controlling the program. Furthermore, the RAM 105 may have provided therein a memory area configured to store setting information, management data or the like of the mobile terminal 101.

The external storage apparatus 106 stores, for example, a print information generating program for generating print information that can be processed by the printing apparatus. The output interface 107 performs control for causing the display unit 108 to display predetermined data, or notify the state of the mobile terminal 101. Typically, a Light-Emitting Diode (LED), a Liquid Crystal Display (LCD) or the like may be used for the display unit 108.

The communication unit 110 can execute data communication by connecting to an apparatus such as the MFP 151 or the AP 131. In addition, the communication unit 110 can also be connected to an AP of the MFP 151, which allows the mobile terminal 101 and the MFP 151 to execute P2P communication. The communication unit 110 may either directly communicate with the MFP 151 by wireless communication, or communicate via the AP 131 or an external apparatus. Here, the external apparatus refers to an external AP (here, the AP 131) outside the mobile terminal 101 and the MFP 151, and also an apparatus that can relay communication other than the AP.

The wireless communication scheme used by the communication unit 110 in the present embodiment is assumed to be Wi-Fi (trade name) compliant with the IEEE802.11 series. The AP 131 may be any known device such as a wireless LAN router.

The short-range wireless communication unit 111, which can execute data communication via wireless connection to an external apparatus such as the MFP 151 at a relatively short distance, performs communication using a different communication scheme from the communication unit 110. The short-range wireless communication unit 111 can be connected to a short-range wireless communication unit 157 in the MFP 151, for example. Examples of the communication scheme include Near Field Communication (NFC), Bluetooth (trade name), Bluetooth Low Energy (BLE), Wi-Fi Aware or the like.

The network interface 112 is a connection interface configured to control communication via wireless communication and communication via a wired LAN cable.

In addition, the USB interface 113 is a connection interface configured to control communication via a USB cable. The foregoing allows for executing data communication when connection to the MFP 151 or an external apparatus such as the external AP 131 is established using a USB cable, for example.

The MFP 151 includes a ROM 152, a RAM 153, a CPU 154, a print engine 155, a communication unit 156, and the short-range wireless communication unit 157. In addition, the MFP 151 further includes an input interface 158, an operation unit 159, an output interface 160, a display unit 161, a network interface 162, and a USB interface 163.

The function of MFP 151 can be implemented by the ROM 152, the RAM 153, the CPU 154 and the like functioning together as a computer, similarly to the mobile terminal 101. In other words, the RAM 153 includes a DRAM, an SRAM or the like, similarly to the RAM 105, and the ROM 152 stores control programs to be executed by the CPU 154, data tables, programs of the OS or the like, similarly to the ROM 104.

The communication unit 156 controls communication processing using each interface. For example, the MFP 151 includes an infrastructure mode and a P2P mode as modes that enable communication using the communication unit 156. For example, the communication unit 156 can operate as an AP in the MFP 151, and thus the MFP 151 operates as the AP when the user instructs activation of the AP. It is assumed that the wireless communication scheme used by the communication unit 156 is compliant with the IEEE802.11 series. The communication unit 156 may include hardware that functions as an AP, or may operate as an AP by software. When operating as a parent station, the communication unit 156 can simultaneously maintain P2P wireless connection with a predetermined number (e.g., three) of child stations, and can execute wireless communication using a frequency band selected from 2.4 GHz, 5 GHz and 6 GHz, for example.

Similar to the short-range wireless communication unit 111, the short-range wireless communication unit 157 has a configuration to perform wireless connection with an apparatus such as the mobile terminal 101 at a short distance, and can connect to the short-range wireless communication unit 111 in the mobile terminal 101, for example.

Based on the information stored in the RAM 153 and the print job received from the mobile terminal 101, the print engine 155 executes a printing processing to form an image by applying a print agent such as ink or liquid to print media such as paper, and outputs the result of printing.

Here, print jobs transmitted from the mobile terminal 101 or the like may generally include a relatively large amount of data, communication of print jobs may require a relatively high-speed communication scheme. The MFP 151 therefore may receive print jobs via the communication unit 156 that can perform communication at a higher speed than the short-range wireless communication unit 157.

Here, an aspect in which a printing processing is performed using ink is exemplified, a printing processing may employ an electrophotographic scheme using toner. In addition, the MFP 151 may be a cartridge type in which a cartridge storing ink is attached, or may be a replenishing type in which ink is replenished from an ink bottle to an ink tank. In addition, the MFP 151 may have a memory such as an external HDD or an SD card attached thereto as an optional device, and information required for operation of the MFP 151 may be stored in the memory.

The input interface 158 accepts an operation input (data input, operation instruction, etc.) from a user operating the operation unit 159. The operation unit 159 may be a virtual keyboard, virtual buttons or the like displayed on the display unit 161. In other words, the input interface 158 can also accept an operation input from the user via the display unit 161, and may form a touch panel display together with the display unit 161.

The output interface 160 performs control for causing the display unit 161 to display predetermined data or notify the state of the MFP 151. Typically, an LED, an LCD or the like may be used for the display unit 161.

In addition, the USB interface 163 is a connection interface configured to control communication via a USB cable, which allows for executing data communication when connection to an external apparatus is established using a USB cable.

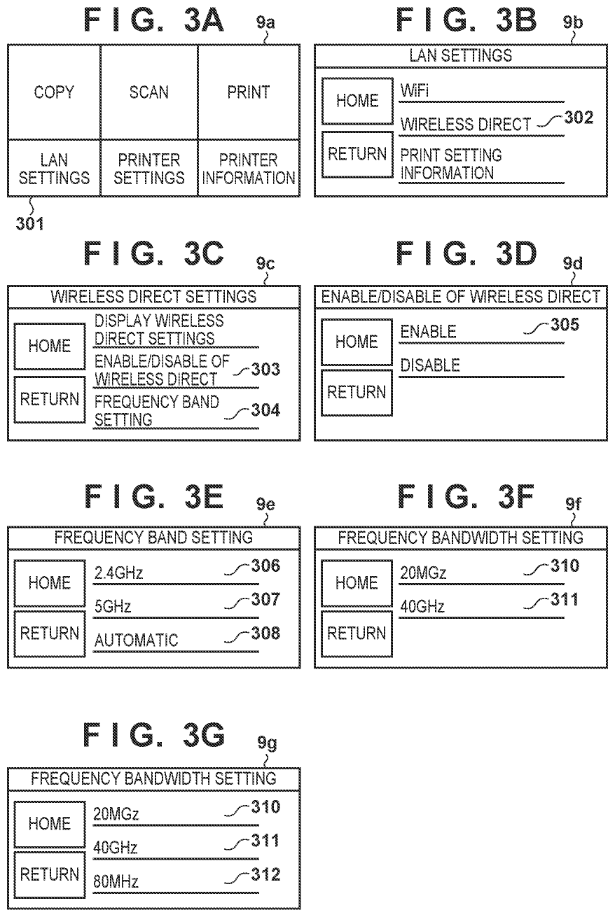

The aforementioned configuration may be of any type as long as it can implement several communication aspects described herein, and partial modification may be added within a range that does not depart from the scope. FIGS. 3A to 3G illustrate examples of a screen 9a or the like of the display unit 161 for performing various settings for direct communication.

As illustrated in FIG. 3A, by selecting a setting unit 301 configured for performing LAN setting on the screen 9a, a screen 9b for performing communication setting such as the infrastructure mode or the direct communication mode is displayed as illustrated in FIG. 3B. The screen 9b includes a setting unit (indicated as Wi-Fi in the drawing) configured for setting the infrastructure mode, a setting unit 302 configured for setting wireless direct communication, and a printing unit configured for print information of the LAN setting.

By selecting the setting unit 302 on the screen 9b, a screen 9c for selecting the setting details of the wireless direct communication is displayed, as illustrated in FIG. 3C.

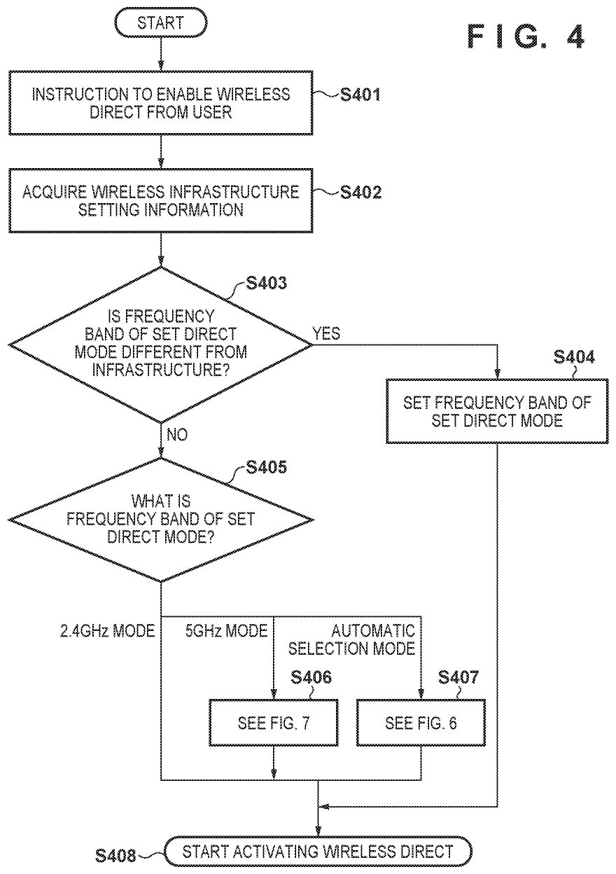

By selecting a unit 303 on the screen 9c that enables or disables the wireless direct communication, a screen 9d for enabling or disabling wireless communication by the wireless direct communication mode of the MFP 151 is displayed, as illustrated in FIG. 3D. When a unit 305 on the screen 9d that enables the wireless direct communication is selected, connection with another device in the wireless direct communication mode is established in a frequency band which is set based on a flowchart of FIG. 4 described later, and communication is enabled.

In addition, by selecting a frequency band setting unit 304 on the screen 9c, a screen 9e for selecting details of the frequency band setting is displayed, as illustrated in FIG. 3E. The screen 9e includes a setting unit 306 configured for setting the frequency band of the wireless direct communication to 2.4 GHz, a setting unit 307 configured for setting the frequency band to 5 GHz, and a setting unit 308 configured for setting the frequency band to be set by an automatic selection mode.

By selecting the setting unit 306 on the screen 9e, a screen 9f for performing detailed setting is displayed, as illustrated in FIG. 3F. The screen 9f includes a setting unit 310 configured for setting the frequency bandwidth of the wireless direct communication to 20 MHz, and a setting unit 311 configured for setting the frequency bandwidth to 40 MHz.

By selecting the setting unit 307 or 308 on the screen 9e, a screen 9g for performing detailed setting is displayed, as illustrated in FIG. 3G. The screen 9g includes a setting unit 310 configured for setting the frequency bandwidth of the wireless direct communication to 20 MHz, a setting unit 311 configured for setting the frequency bandwidth to 40 MHz, and a setting unit 312 configured for setting the frequency bandwidth to 80 MHz.

FIG. 4 illustrates a flowchart for changing the wireless direct setting for a case where the wireless direct is activated subsequently or additionally, in a state where connection of the wireless infrastructure is established.

At Step S401 (simply referred to as “S401” below; the same goes for other steps described later), the CPU 103 accepts selection of enabling the wireless direct communication from the user.

At S402, the CPU 103 acquires information about the wireless infrastructure for which communication has been established, for example, information of channel, frequency band, frequency bandwidth, radio wave strength or the like. The foregoing may be implemented by the CPU 103 reading, from the RAM 153, parameters (wireless parameters) that were held when the connection of the wireless infrastructure is established.

At S403, the CPU 103 compares a frequency band of the wireless infrastructure acquired at S402 with a frequency band of the wireless direct (setting value by the user) which has been set on the screen 9e. The processing proceeds to S404 when the values are different from each other, or the processing proceeds to S405 when the values are equal to each other.

At S404 (when the frequency bandwidths are different between the wireless infrastructure and the wireless direct), the CPU 103 causes the MFP 151 to operate, in the frequency bandwidth which has been set on the screen 9e, as a group owner (or an internal AP) in the wireless direct.

At S405, the CPU 103 reads, from the RAM 153, a setting value of the frequency band of the wireless direct which has been set by the user on the screen 9f or 9g. When the setting value is 2.4 GHz, the wireless direct is enabled in the frequency band which has been set on the screen 9e (S408). In addition, the processing proceeds to S406 when the setting value is 5 GHz, or the processing proceeds to S407 when the setting value is set by the automatic selection mode.

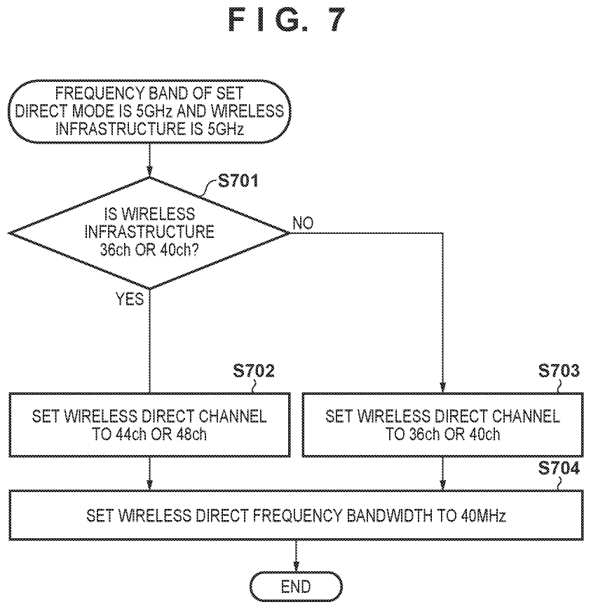

At S406 (i.e., when the setting value of the frequency band of the wireless direct is 5 GHz and that of the wireless infrastructure is also 5 GHz), the CPU 103 changes the frequency bandwidth of the wireless direct communication and enables the wireless direct (S408), based on a flowchart of FIG. 7 described later.

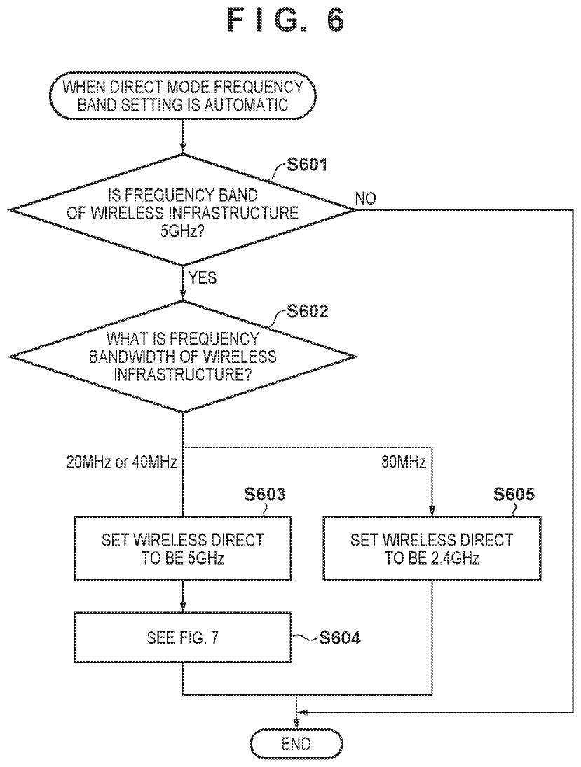

At S407 (i.e., when the setting value of the frequency band of the wireless direct is set by the automatic selection mode), the CPU 103 changes the frequency band or the frequency bandwidth of the wireless direct communication and enables the wireless direct (S408), based on the flowchart of FIG. 6 described later.

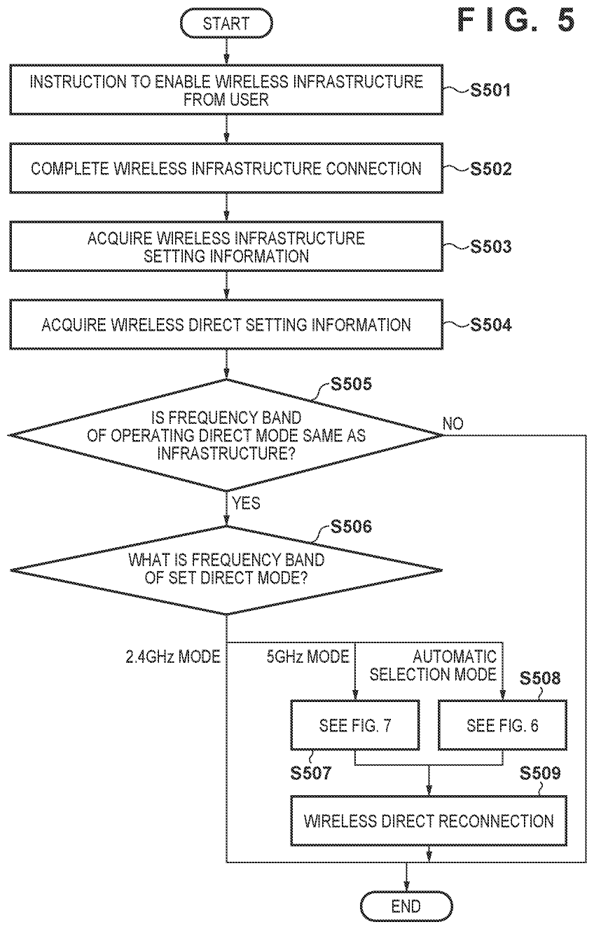

FIG. 5 illustrates a flowchart for changing the setting of the wireless direct for a case where the wireless infrastructure is activated subsequently or additionally, in a state where the wireless direct connection is established.

At S501, the CPU 103 accepts selection of enabling wireless infrastructure from the user.

At S502, the CPU 103 activates the wireless infrastructure according to the setting accepted at S501 and specified by the user.

At S503, the CPU 103 acquires information about the wireless infrastructure for which communication has been established, for example, information of channel, frequency band, frequency bandwidth, radio wave strength or the like. The foregoing may be implemented by the CPU 103 reading, from the RAM 153, parameters (wireless parameters) that were held when the connection of the wireless infrastructure is established.

At S504, the CPU 103 acquires information about the wireless direct for which communication has been established, for example, information of channel, frequency band, frequency bandwidth, radio wave strength or the like. The foregoing may be implemented by the CPU 103 reading, from the RAM 153, parameters (wireless parameters) that were held when the wireless direct connection is established.

At S505, the CPU 103 compares the frequency band of the wireless infrastructure held in the RAM 153 with the frequency band of the wireless direct held in the RAM 153 (setting value provided by the user). When these values are equal to each other, the processing proceeds to S506, and when these values are different from each other, the flowchart is terminated.

At S506, the CPU 103 reads, from the RAM 153, the setting value of the frequency band of the wireless direct which has been set on the screen 9e. When the setting value is 2.4 GHz, the flowchart is terminated. When the setting value is 5 GHz, the processing proceeds to S507, and when the setting value is set by the automatic selection mode, the processing proceeds to S508.

At S507 (i.e., when the setting value of the frequency band of the wireless direct is 5 GHz and that of the wireless infrastructure is also 5 GHz), the CPU 103 changes the frequency bandwidth of the wireless direct communication and enables the wireless direct (S509), based on the flowchart of FIG. 7 described later.

At S508 (i.e., when the setting value of the frequency band of the wireless direct is set by the automatic selection mode), the CPU 103 changes the frequency band or the frequency bandwidth of the wireless direct communication and enables the wireless direct (S509), based on the flowchart of FIG. 6 described later.

FIG. 6 illustrates a flowchart for changing the frequency bandwidth of the wireless direct communication when the wireless direct connection is established and the setting value of the frequency band of the wireless direct communication is set by the automatic selection mode.

At S601, the CPU 103 reads the frequency band of the wireless infrastructure held in the RAM 153 at S402 or S503 and determines whether the frequency band is 5 GHz. When the frequency band of the wireless infrastructure is 5 GHz, the processing proceeds to S602, otherwise, the flowchart is terminated, and the frequency band of the wireless direct may incidentally be set to be 5 GHz.

At S602, the CPU 103 reads the frequency bandwidth of the wireless infrastructure which has been held in the RAM 153 at S402 or S503. When the frequency bandwidth is 20 MHz or 40 MHz, the processing proceeds to S603, or the processing proceeds to S605 when the frequency bandwidth is 80 MHz.

Here, when the frequency band of the wireless infrastructure is 5 GHz and the frequency bandwidth of the wireless infrastructure is not 80 MHz, it is conceivable that there is a frequency bandwidth with no interference in a 5-GHz band that can be used by the MFP 151 (i.e., the so-called W52 referring to a 5.2 GHz band of 5150 to 5250 MHz). The CPU 103 therefore sets, at S603, the frequency band of the wireless direct to be 5 GHz and proceeds to S604.

Here, W52 includes a plurality of channels of 36ch, 40ch, 44ch and 48ch. The fact that each channel corresponds to a frequency bandwidth and the frequency bandwidth is 80 MHz, corresponds to the fact that all the plurality of channels are in an available state, whereas the fact that the frequency bandwidth is not 80 MHz corresponds to the fact that some of the channels are in a non-used state/idle state.

At S604 (i.e., when the setting value of the frequency band of the wireless direct is 5 GHz and wireless infrastructure is also connected at 5 GHz), the CPU 103 changes the frequency bandwidth of the wireless direct communication, based on the flowchart of FIG. 7 described later.

When, on the other hand, the frequency band of the wireless infrastructure is 5 GHz and the frequency bandwidth of the wireless infrastructure is 80 MHz, all bands of the 5-GHz band available by the MFP 151, i.e., all bands of the frequency band of W52 are occupied. Therefore, when the setting value of the frequency band of the wireless direct is set by the automatic selection mode, the CPU 103 sets the frequency band of the wireless direct to be 2.4 GHz at S605, whereby decrease of throughput due to communication interference can be avoided.

FIG. 7 is a flowchart illustrating processing of changing the frequency bandwidth of the wireless direct communication when the setting value of the frequency band of the wireless direct is 5 GHz and the wireless infrastructure is also connected at 5 GHz.

At S701, the CPU 103 reads a channel of the wireless infrastructure held in the RAM 153 at S402 or S503, and determines whether the channel of the wireless infrastructure is 36ch or 40ch. When the channel of the wireless infrastructure is 36ch or 40ch, the processing proceeds to S702, otherwise (44ch or 48ch) the processing proceeds to S703.

At S702 (i.e., when the channel of the wireless infrastructure is 36ch or 40ch), the CPU 103 sets the channel of the wireless direct to be 44ch or 48ch and proceeds to S704.

At S703 (i.e., when the channel of the wireless infrastructure is 44ch or 48ch), the CPU 103 sets the channel of the wireless direct to be 36ch or 40ch and proceeds to S704.

At S704, the CPU 103 sets the frequency bandwidth of the wireless direct to be 40 MHz. When the frequency bandwidth of the wireless infrastructure is 20 MHz or 40 MHz, decrease of throughput due to communication interference can be avoided. Alternatively, the frequency bandwidth of the wireless infrastructure is incidentally set to be the 40 MHz, whereby decrease of throughput due to communication interference can be avoided.

In the communication standard compliant with the IEEE802.11 series, a case of the frequency bandwidth of the wireless infrastructure of 80 MHz mainly corresponds to IEEE802.11ac or IEEE802.11ax. In a wireless LAN, data transmission is started when a data transmitting side sends a Request To Send (RTS) signal to a receiving side and the receiving side returns a Clear To Send (CTS) signal to the transmitting side, and communication is performed by repeating transmitting/returning RTS/CTS signals. Although the CPU 103 transmits the RTS signal, the receiving side does not transmit the CTS signal when there is no idle channel. In a case where the wireless infrastructure is operating at 80 MHz, if the CPU 103 performs wireless direct at 40 MHz, the CPU 103 stops receiving the CTS signal. The CPU 103 thereby detects a frequency band interference, and therefore the CPU 103 performs communication at 40 MHz with the wireless infrastructure operating at 80 MHz.

As has been described above, it is possible to avoid communication interference and suppress decrease of throughput, thereby improving the convenience of communication between components in the wireless communication system SY.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Individual components in the foregoing embodiments are named using expressions based on their main functions, the functions mentioned in the embodiments may be sub-functions and the nomenclature is not strictly limited to such expressions. In addition, the expressions are replaceable by similar expressions. To the same effect, expressions such as “unit” or “portion” can be replaced by “tool”, “component”, “member”, “structure”, “assembly” or the like. Alternatively, they may be omitted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-170866, filed on Oct. 25, 2022, which is hereby incorporated by reference herein in its entirety.

What is claimed is:

1. A communication apparatus that can execute wireless communication with another communication apparatus, the communication apparatus comprising:
at least one memory and at least one processor and/or at least one circuit which function as:
a control unit configured to control to communicate with at least one of a plurality of communication modes including a first mode in which wireless communication is performed with another communication apparatus via a relay apparatus by a communication scheme compliant with a predetermined communication standard, and a second mode in which wireless communication is performed with another communication apparatus not via a relay apparatus by a communication scheme compliant with the predetermined communication standard;
an acquisition unit configured to acquire information of a frequency band used for communication in the first mode and a frequency band used for communication in the second mode; and
a setting unit configured to set such that, when communication in the first mode and communication in the second mode are both performed in a first frequency band, the communication in the first mode is performed in a part of a frequency bandwidth in the first frequency band, and the communication in the second mode is performed in another part of a frequency bandwidth in the first frequency band.

2. The communication apparatus according to claim 1, wherein a frequency band in a 5-GHz band that can be used by the communication apparatus is that of 5150 to 5250 MHz.

3. The communication apparatus according to claim 2, wherein the first frequency band is that of 5150 to 5250 MHz.

4. The communication apparatus according to claim 3, wherein, when a channel used for communication in the first mode includes at least one of 36ch and 40ch included in the frequency band of 5150 to 5250 MHz, the setting unit sets, based on information acquired by the acquisition unit, a channel used for communication in the second mode to be at least one of 44ch and 48ch.

5. The communication apparatus according to claim 4, wherein, when a channel used for communication in the first mode includes at least one of 44ch and 48ch included in the frequency band of 5150 to 5250 MHz, the setting unit sets, based on the information acquired by the acquisition unit, a channel used for the communication in the second mode to be at least one of 36ch and 40ch.

6. The communication apparatus according to claim 1, wherein, the setting unit performs the setting, when transitioning from a first state in which communication is performed in the first mode in the first frequency band and communication is not performed in the second mode to a second state in which communication is performed in the second mode using the first frequency band in addition to the communication in the first mode.

7. The communication apparatus according to claim 6, wherein the setting unit sets the frequency bandwidth used in the first mode in the second state to be a predetermined frequency bandwidth that is more limited than in the first state.

8. The communication apparatus according to claim 7, wherein the predetermined frequency bandwidth is 40 MHz.

9. The communication apparatus according to claim 7, wherein, when the frequency bandwidth that has been used in the first mode in the first state is 80 MHz, the setting unit sets the frequency bandwidth used in the first mode in the second state to be a predetermined frequency bandwidth that is more limited than in the first state.

10. The communication apparatus according to claim 6, wherein the setting unit sets the frequency bandwidth used in the second mode to be a predetermined frequency bandwidth.

11. The communication apparatus according to claim 1, wherein
the at least one memory and at least one processor and/or at least one circuit further function as an accepting unit configured to accept a setting of the frequency band of the second mode from a user, and
in a case where the setting accepted by the accepting unit is an automatic selection mode, and when the first mode is performed in the entire frequency bandwidth in the first frequency band, the setting unit sets the second mode to be performed in a second frequency band that is different from the first frequency band.

12. The communication apparatus according to claim 2, wherein, in a case where the setting accepted by an accepting unit is an automatic selection mode, and when the first mode is performed in a part of the frequency bandwidth in the first frequency band, the setting unit sets the second mode to be performed in another part of the frequency bandwidth in the first frequency band.

13. The communication apparatus according to claim 12, wherein, in a case where the setting accepted by the accepting unit is the first frequency band, and when the first mode is performed in the entire frequency bandwidth in the first frequency band, the setting unit sets the first mode to be performed in a part of the frequency bandwidth by limiting the frequency bandwidth in the first frequency band, and sets the second mode to be performed in another part of the frequency bandwidth in the first frequency band.

14. The communication apparatus according to claim 1, wherein the communication standard includes IEEE802.11 series.

15. The communication apparatus according to claim 14, wherein the communication standard includes at least one of IEEE802.11ac and IEEE802.11ax.

16. The communication apparatus according to claim 5, wherein the first mode is an infrastructure mode, the second mode is a direct mode, and the first frequency band is a frequency bandwidth included in a 5-GHz band.

17. A wireless communication system comprising: a communication apparatus that can execute wireless communication with another communication apparatus; the other communication apparatus; and a relay apparatus, the communication apparatus further comprising:
at least one memory and at least one processor and/or at least one circuit which function as:
a control unit configured to control to communicate with at least one of a plurality of communication modes including a first mode in which wireless communication is performed with another communication apparatus via a relay apparatus by a communication scheme compliant with a predetermined communication standard, and a second mode in which wireless communication is performed with another communication apparatus not via a relay apparatus by a communication scheme compliant with the predetermined communication standard;
an acquisition unit configured to acquire information of a frequency band used for communication in the first mode and a frequency band used for communication in the second mode; and
a setting unit configured to set such that, when communication in the first mode and communication in the second mode are both performed in a first frequency band, the communication in the first mode is performed in a part of a frequency bandwidth in the first frequency band, and the communication in the second mode is performed in another part of a frequency bandwidth in the first frequency band.

18. A computer-readable storage medium storing a program, the program configured to cause a computer to function as:
a control unit configured to control to communicate with at least one of a plurality of communication modes including a first mode in which wireless communication is performed with another communication apparatus via a relay apparatus by a communication scheme compliant with a predetermined communication standard, and a second mode in which wireless communication is performed with another communication apparatus not via a relay apparatus by a communication scheme compliant with the predetermined communication standard;
an acquisition unit configured to acquire information of a frequency band used for communication in the first mode and a frequency band used for communication in the second mode; and
a setting unit configured to set such that, when communication in the first mode and communication in the second mode are both performed in a first frequency band, the communication in the first mode is performed in a part of a frequency bandwidth in the first frequency band, and the communication in the second mode is performed in another part of a frequency bandwidth in the first frequency band.

19. A communication method for executing wireless communication with another communication apparatus comprising:
controlling to communicate with at least one of a plurality of communication modes including a first mode in which wireless communication is performed with another communication apparatus via a relay apparatus by a communication scheme compliant with a predetermined communication standard, and a second mode in which wireless communication is performed with another communication apparatus not via a relay apparatus by a communication scheme compliant with the predetermined communication standard;
acquiring information of a frequency band used for communication in the first mode and a frequency band used for communication in the second mode; and
setting such that, when communication in the first mode and communication in the second mode are both performed in a first frequency band, the communication in the first mode is performed in a part of a frequency bandwidth in the first frequency band, and the communication in the second mode is performed in another part of a frequency bandwidth in the first frequency band.
